(19) United States
(12) Patent Application Publication
(10) Pub. No.: US 2004/0240169 A1
(43) Pub. Date: Dec. 2, 2004

(54) Non-screw fastening device for computer floppy drive

(76) Inventor: Wen-Liang Wu, Tainan (TW)

Correspondence Address: BIRCH STEWART KOLASCH & BIRCH, PO BOX 747, FALLS CHURCH, VA, 22040-0747, US

(21) Appl. No.: 10/449,390

(22) Filed: Jun. 2, 2003

(51) Int. Cl. G06F 1/16

(52) U.S. Cl. 361/685

(57) ABSTRACT

The invention provides a non-screw fastening device for a computer floppy drive, which includes a mounting rack for a computer drive. The mounting rack for a computer drive is specifically designed to provide a sliding path on one side face of the mounting rack. Besides, one face of an L-shaped positioning sheet is to be joined onto the sliding path of the mounting rack, whereas the positioning protrusions are provided on another face of the positioning sheet corresponding to the positioning holes on the mounting rack. Also, a flexible position restoration structure is provided between the positioning sheet and the mounting rack so that the drive can be installed and uninstalled rapidly by hand without applying any tool.

### FIELD OF THE INVENTION

The invention relates to a structure of computer casing and, more particularly, to a structure design that allows the drive inside the mounting rack of the computer casing to be rapidly installed to or uninstalled from the mounting rack without applying any tool.

### BACKGROUND OF THE INVENTION

A floppy drive is an essential device in a computer casing, and at present a small-sized three-inch floppy drive is most commonly used in the market. Also, a rectangle-shaped drive mounting rack is often used in a computer casing, wherein different kinds of drives can be simultaneously installed onto the mounting rack. Alternatively, a single floppy drive mounting rack can be used instead, which allows a drive to be inserted into the mounting rack. When installation, two side faces of the drive are fastened to the drive mounting rack, and a screw is used to fasten the driver onto the mounting rack. In general, about four pieces of screws are required for fastening a small-sized floppy drive, and a screwdriver is also required when the screw fastening is applied. However, because the space inside the computer casing is very small, it is never an easy job to do screwing or unscrewing inside the casing. Therefore, installing and uninstalling a floppy drive has been a time-consuming and labor-consuming job that needs to be improved.

### SUMMARY OF THE INVENTION

The object of the invention is to provide a non-screw fastening device for a computer floppy drive, which is designed to facilitate installing and uninstalling a computer drive rapidly and easily by hand without applying any tool.

To achieve the foregoing object, a non-screw fastening device for a computer floppy drive provided by the invention includes a computer drive mounting rack, which is specifically designed with a sliding path provided on one side face of the mounting rack. Besides, one face of an L-shaped positioning sheet is joined to the sliding path of the mounting rack, whereas positioning protrusions in accordance with positioning holes on the drive are provided on the other face of the L-shaped positioning sheet. In addition, a flexible position restoration structure is provided between the positioning sheet and the mounting rack. Thus, the drive can be quickly installed and uninstalled by hand without any tool aid.

Alternatively, unlike a conventional mounting rack that is usually to be integrally formed with its drive, the mounting rack of the invention can be a single floppy drive mounting rack. According to the single mounting rack of the invention, one side face of the bottom face of the mounting rack is used to fasten a floppy disk, whereas the other side face is to be connected to a narrow fastening panel for corresponding to a smaller-sized floppy drive. Conventionally, to fasten a conventional floppy drive is to provide two screw holes on one side face of the floppy drive so that the floppy drive can be screwed onto the mounting rack. Accordingly, in the invention, two positioning protrusions are also provided on the L-shaped positioning sheet, and two positioning holes are provided on the floppy drive inside the mounting rack corresponding to the positioning protrusions. Thus, when the positioning protrusions are inset into the positioning holes, the effect of positioning the floppy drive can be obtained. Moreover, the positioning sheet can be shifted, allowing the positioning protrusions to be detached from the positioning holes of the floppy drive so that the floppy drive can be installed and uninstalled conveniently. On the other hand, when the positioning sheet is released, the positioning sheet will go back to its original place so that the positioning protrusions can be inset back into the positioning holes.

### BRIEF DESCRIPTION OF THE DRAWINGS

FIG. 1 is a perspective schematic diagram of one embodiment of the invention.

FIG. 2 is a partially perspective exploded view of one embodiment of the invention.

FIG. 3 is a schematic plan view of one embodiment of the invention.

FIG. 4 is a right elevation view of one embodiment of the invention.

FIG. 5 is a top view of one embodiment of the invention.

FIG. 6 is a side elevation view showing a positioning sheet in another embodiment of the invention.

### DETAILED DESCRIPTION OF THE PREFERRED EMBODIMENTS

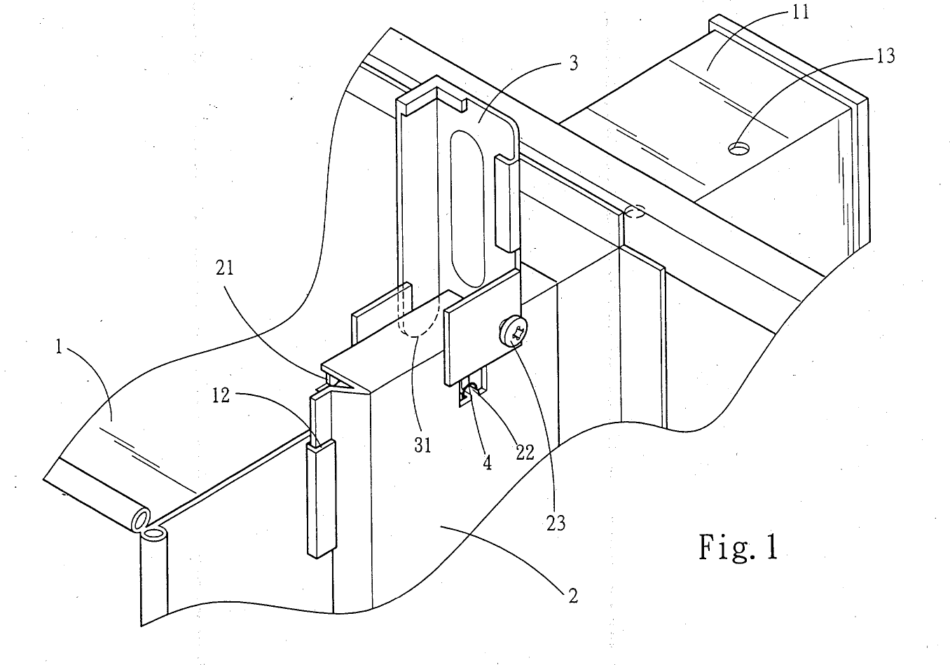

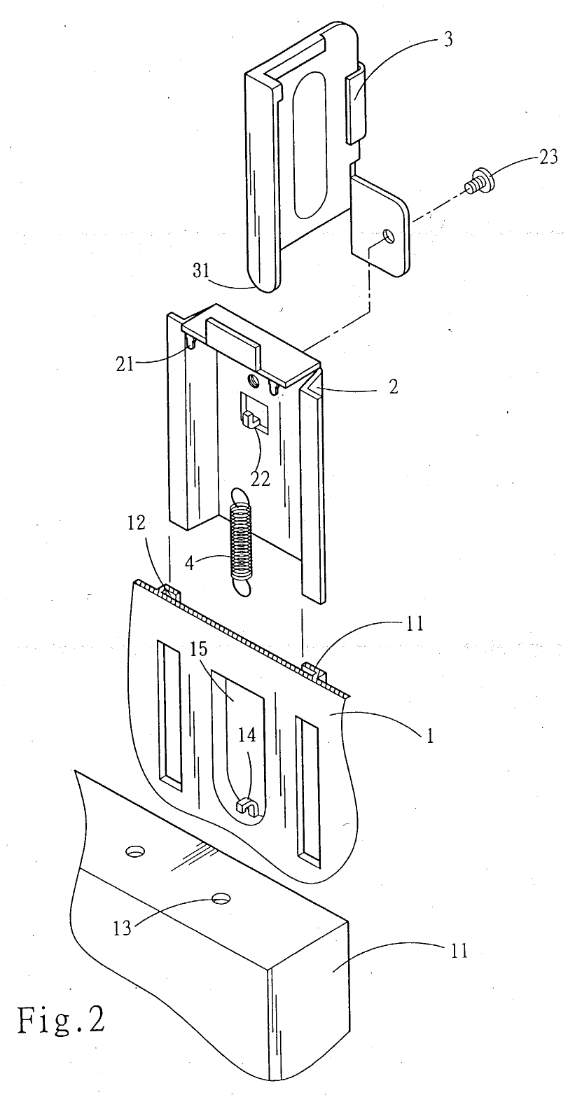

Referring to FIGS. 1 & 2, the non-screw fastening device for a computer floppy drive of the invention includes:

a mounting rack 1, wherein a floppy drive 11 is to be sleeved into the inner space of the mounting rack 1, and a sliding path 12 is laterally provided at the bottom face of the mounting rack 1; besides, two positioning holes 13 are appropriately located at the floppy drive 11, and a lower hook 14 is provided at the mounting rack 1;

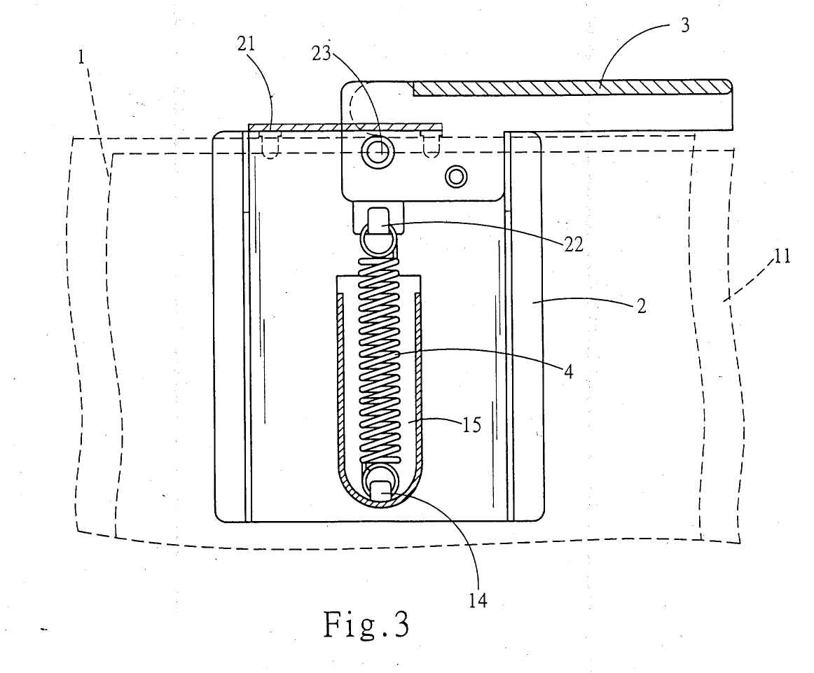

an L-shaped positioning sheet 2, wherein two rails are separately provided extending from two sides of one face of the positioning sheet 2, and the rails are to be joined to the sliding path 12 of the mounting rack 1; besides, two positioning protrusions 21 are provided at one folding face of the positioning sheet 2 corresponding to the two positioning holes 13 on the side face of the floppy drive 11, wherein the positioning protrusions 21 can be laterally inset into the positioning holes 13; also, an upper hook 22 is provided on the positioning sheet 2, and a pivot pin 23 is provided on the positioning sheet 2 near the L-shaped bending portion and is pivotally connected to a wrench 3. As to the wrench 3, as shown in FIG. 3, it can pull the positioning sheet 2 for a lateral shift. Besides, the length between the center of the pivot pin 23 and the bottom edge 31 of the wrench 3 is longer than the sticking-out length of each positioning protrusion 21; and

a position-restoring spring 4, as shown in FIGS. 3 & 4, wherein one end of the position-restoring spring 4 is hooked to the upper hook 22 of the positioning sheet 2, and the other end of the same is hooked to the lower hook 14 of the mounting rack 1 to form a flexible position restoration structure.

Moreover, a through hole 15 is provided on the mounting rack 1 of the invention, and the position-restoring spring 4 can be placed inside the through hole 15. Also, the lower hook 14 is formed at the outer wall of the through hole 15 and to be hooked to one end of the position-restoring spring 4, whereas the upper hook 22 of the positioning sheet 2 is provided near the L-shaped bending portion so as to be hooked to the other end of the position-restoring spring 4; therefore, the lower hook 14 can be connected to the upper hook 22 and parallel to the sliding path 12. Hence, the space occupied in the invention can be reduced, and the length of the position-restoring spring 4 can be shortened as well.

FIG. 6 shows another embodiment of the invention, which includes a mounting rack 1, wherein a floppy drive 11 can be provided therein, and a sliding path 12 is provided at one side face of the mounting rack 1. Besides, one face of an L-shaped positioning sheet 2 is joined to the sliding path 12 of the mounting rack 1, whereas two positioning protrusions 21 are provided on the other face of the L-shaped positioning sheet 2. In addition, the two protrusions 21 can be inset into the two positioning holes 13 of the floppy drive 11. Also, a lower hook 14 is provided on the mounting rack 1, and an upper hook 22 is provided on the positioning sheet 2. Thus, a position-restoring spring 4 can be hooked between the upper hook 22 and the lower hook 14. Moreover, a hand bar 24 is bent sticking outwardly from the L-shaped positioning sheet 2, and the hand bar 24 can be pulled by hand, which in turn enables the positioning sheet 2 to make a shift along the sliding path 12. On the other hand, when the hand bar 24 is released, the positioning sheet 2 can restore to its original place through the resilience generated by the position-restoring spring 4.

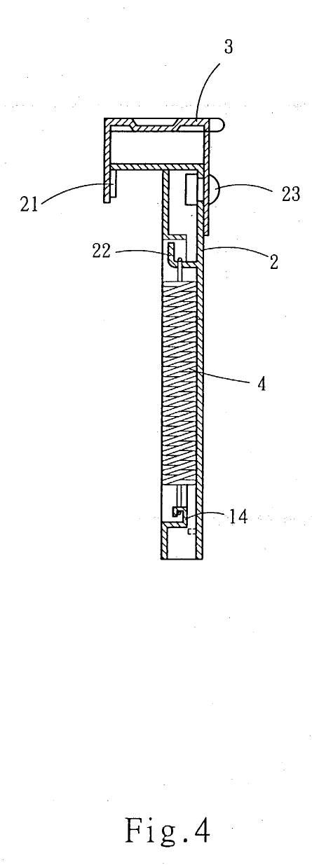

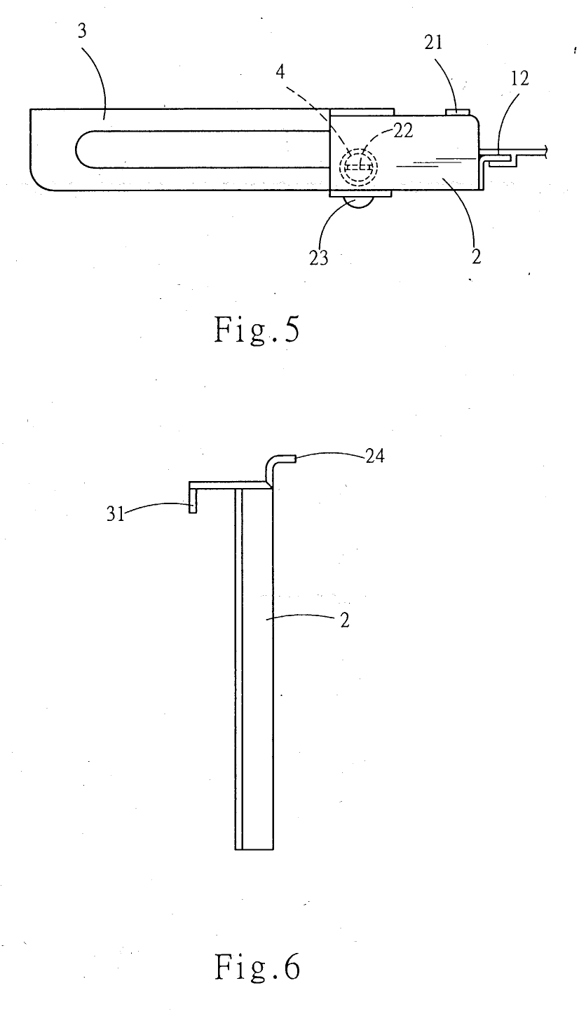

Furthermore, referring to FIGS. 3, 4 & 5 for operating the fastening device, first, the wrench 3 of the positioning sheet 2 will be pulled by hand to make a turn so that the wrench 3 will be facing outwards. Then, the bottom edge 31 at the other side of the wrench 3 can be laterally joined to the sidewall face of the mounting rack 1. Therefore, the positioning sheet 2 can be shifted due to lateral pulling force, which in turn allows the two positioning protrusions 21 of the positioning sheet 2 to be detached from the two positioning holes 13 at the side face of the floppy drive 11. Then, the floppy drive 11 can be pulled out from the box body of the mounting rack 1. On the other hand, when the floppy drive 11 is to be put back, the wrench 3 should again be pulled by hand, and then the floppy drive 11 can be put back into the box body of the mounting rack 1. After that, the wrench 3 will be released by hand, and the resilience generated by the position-restoring spring 4 may enable the positioning sheet 2 to restore back to the sliding path 12 of the mounting rack 1. Meanwhile, the two positioning protrusions 21 at the side face of the positioning sheet 2 can be inset into the positioning holes 13 of the floppy drive 11 separately. Hence, the floppy drive 11 can be installed to and uninstalled from the mounting rack 1 rapidly and securely without applying any tool.

What is claimed is:

1. A non-screw fastening device for a computer floppy drive, including a mounting rack for a computer drive, wherein a sliding path is laterally provided at the bottom face of one side of the mounting rack, and one face of an L-shaped positioning sheet is to be joined onto the sliding path of the mounting rack, whereas a plurality of positioning protrusion is provided on another face of the L-shaped positioning sheet corresponding to a plurality of positioning hole on the drive; besides, a flexible position restoration structure is provided between the positioning sheet and the mounting rack.

2. The non-screw fastening device for a computer floppy drive as claimed in claim 1, wherein a wrench is pivotally connected to the outer side face of the positioning sheet, and a pivot pin is used to pivotally connect the wrench to the positioning sheet near its bending portion; besides, the length between the center of the pivot pin and the bottom edge of the wrench is longer than the length of each positioning protrusion.

3. The non-screw fastening device for a computer floppy drive as claimed in claim 1, wherein a hand bar is provided extending from the outer side face of the positioning sheet.

4. The non-screw fastening device for a computer floppy drive as claimed in claim 1, wherein the position restoration structure includes a position-restoring spring, and one end of the position-restoring spring is hooked to an upper hook of the positioning sheet, whereas the other end of the position-restoring spring is hooked to a lower hook of the mounting rack.

5. The non-screw fastening device for a computer floppy drive as claimed in claim 4, wherein a through hole is provided on the mounting rack, and the lower hook is provided extending from the outer wall of the through hole; besides, the position-restoring spring is placed inside the through hole.

6. The non-screw fastening device for a computer floppy drive as claimed in claim 1, wherein two positioning protrusions are provided on the positioning sheet to be inset into the positioning holes of the mounting rack.
